(19) United States
(12) Patent Application Publication
(10) Pub. No.: US 2018/0233306 A1
(43) Pub. Date: Aug. 16, 2018

(54) KEYBOARD DEVICE

(71) Applicant: Primax Electronics Ltd., Taipei (TW)

(72) Inventors: CHIA-YUAN CHANG, Taipei (TW); CHUN-LIN CHU, Taipei (TW)

(21) Appl. No.: 15/629,248

(22) Filed: Jun. 21, 2017

(30) Foreign Application Priority Data
Feb. 10, 2017 (TW) 106104455

(51) Int. Cl. H01H 13/702

(52) U.S. Cl. CPC H01H 13/702

(57) ABSTRACT

A keyboard device includes three detachable keyboard modules. In a stored state, a first base of a keyboard module and a second base of a second keyboard module are located over a third base of a third keyboard module. Moreover, plural key structures of the third keyboard module are accommodated within an accommodation space that is defined by a receiving recess of the first keyboard module and a receiving recess of the second keyboard module. In a usage state, the first keyboard module and the second keyboard module are horizontally combined with two lateral sides of the third keyboard module, plural key structures of the first keyboard module are supported by a first side of the third base and the first base collaboratively, and plural key structures of the second keyboard module are supported by a second side of the third base and the second base collaboratively.

### FIELD OF THE INVENTION

The present invention relates to an input device, and more particularly to a keyboard device.

### BACKGROUND OF THE INVENTION

Generally, the widely-used peripheral input device of a computer system includes for example a mouse device, a keyboard device, a trackball device, or the like. Via the keyboard device, characters or symbols can be inputted into the computer system directly. As a consequence, most users and most manufacturers of the input devices pay much attention to the keyboard devices.

Hereinafter, the structure and the function of a conventional keyboard device will be illustrated with reference to FIG. 1. FIG. 1 is a schematic top view illustrating the outward appearance of a conventional keyboard device. As shown in FIG. 1, plural keys 10 are installed on a surface of the conventional keyboard device 1. These keys 10 are classified into some types, e.g. ordinary keys, numeric keys and function keys. When one or more keys 10 are depressed by the user's fingers, a corresponding key signal is generated to the computer, and thus the computer executes a function corresponding to the depressed key or keys. For example, when an ordinary key is depressed, a corresponding English letter or symbol is inputted into the computer. When a numeric key is depressed, a corresponding number is inputted into the computer. In addition, the function keys (F1˜F12) can be programmed to provide various quick access functions.

However, since the size of the conventional keyboard device 1 is too large, it is difficult to carry the keyboard device 1. For solving these drawbacks, some novel keyboard devices have been introduced into the market. FIG. 2 schematically illustrates the outward appearance of another conventional keyboard device. As shown in FIG. 2, the size of the key structure 20 of the keyboard device 2 is reduced and the distance between every two adjacent key structures 20 is shortened. Obviously, it is difficult for the user to operate this keyboard device 2. FIG. 3 is a schematic top view illustrating the outward appearance of another conventional keyboard device. The keyboard device 3 as shown in FIG. 3 is a foldable keyboard device. Through a joint structure 31 in a middle region of the keyboard device 3, the keyboard device 3 can be folded and stored. However, the arrangement of the joint structure 31 causes another problem. For example, since the distance between the both sides of the joint structure 31 is increased, the tactile feel of the keyboard device to the user is adversely affected.

Therefore, there is a need of providing a keyboard device with enhanced tactile feel and easy portability.

Therefore, the conventional key structure and the scissors-type connecting member need to be further improved.

### SUMMARY OF THE INVENTION

An object of the present invention provides a keyboard device with plural individually detachable keyboard modules. By changing the combination of these keyboard modules, the operating state of the keyboard device is switched from a usage state to a stored state or switched from the stored state to the usage state. By this design, the tactile feel and operating convenience of the keyboard device to the user are not adversely affected.

In accordance with an aspect of the present invention, there is provided a keyboard device. The keyboard device includes a first keyboard module, a second keyboard module and a third keyboard module. The first keyboard module includes a first base and plural first key structures. The plural first key structures are located over the first base. The first base has a first receiving recess. The second keyboard module includes a second base and plural second key structures. The plural second key structures are located over the second base. The second base has a second receiving recess. The third keyboard module includes plural third key structures and a third base. The third base is located under the plural third key structures to support the plural third key structures. When the keyboard device is in a stored state, the first base and the second base are located over the third base, and the plural third key structures are accommodated within an accommodation space that is defined by the first receiving recess and the second receiving recess. When the keyboard device is in a usage state, the first keyboard module and the second keyboard module are detached from each other, the first keyboard module and the second keyboard module are horizontally and respectively combined with a first lateral side and a second lateral side of the third keyboard module, the plural first key structures are supported by a first side of the third base and the first base collaboratively, and the plural second key structures are supported by a second side of the third base and the second base collaboratively.

In accordance with another aspect of the present invention, there is provided a keyboard device. The keyboard device includes a first keyboard module, a second keyboard module and a third keyboard module. The first keyboard module includes a first base, a first signal transmission part and plural first key structures. The plural first key structures are located over the first base. The second keyboard module includes a second base, a second signal transmission part and plural second key structures. The plural second key structures are located over the second base. The third keyboard module includes a third base, a third signal transmission part and plural third key structures. The plural third key structures are located over the third base. When the keyboard device is in a stored state, the first keyboard module and the second keyboard module are combined together and the first base and the second base are located over or under the third base. When the keyboard device is in a usage state, the first keyboard module and the second keyboard module are detached from each other, the first keyboard module and the second keyboard module are horizontally combined with a first lateral side and a second lateral side of the third keyboard module, respectively, and the first signal transmission part and the second signal transmission part are electrically connected with the third signal transmission part.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outward appearance of a conventional keyboard device;

FIG. 2 schematically illustrates the outward appearance of another conventional keyboard device;

FIG. 3 is a schematic top view illustrating the outward appearance of another conventional keyboard device;

FIG. 4 is a schematic perspective view illustrating a keyboard device according to an embodiment of the present invention, in which the keyboard device is in a stored state;

FIG. 5 is a schematic perspective view illustrating keyboard device according to the embodiment of the present invention, in which the keyboard device is in a usage state;

FIG. 6 is a schematic exploded view illustrating keyboard device of FIG. 5 and taken along a viewpoint;

FIG. 7 is a schematic exploded view illustrating keyboard device of FIG. 5 and taken along another viewpoint;

FIG. 8 is a schematic exploded view illustrating the first membrane circuit board, the second membrane circuit board and the third membrane circuit board of the keyboard device as shown in FIG. 5;

FIG. 9 is a schematic exploded view illustrating keyboard device of FIG. 4 and taken along a viewpoint; and

FIG. 10 is a schematic exploded view illustrating keyboard device of FIG. 4 and taken along another viewpoint.

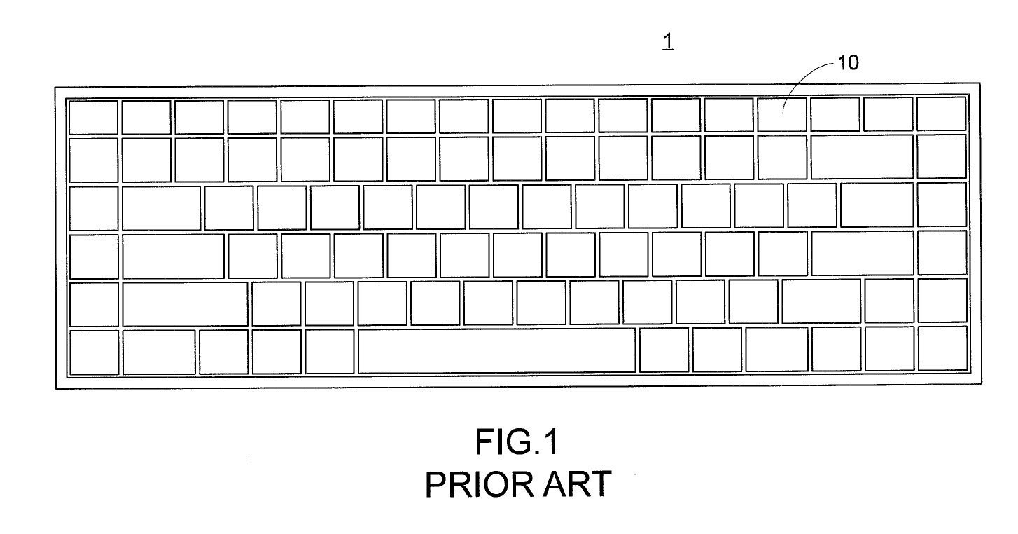

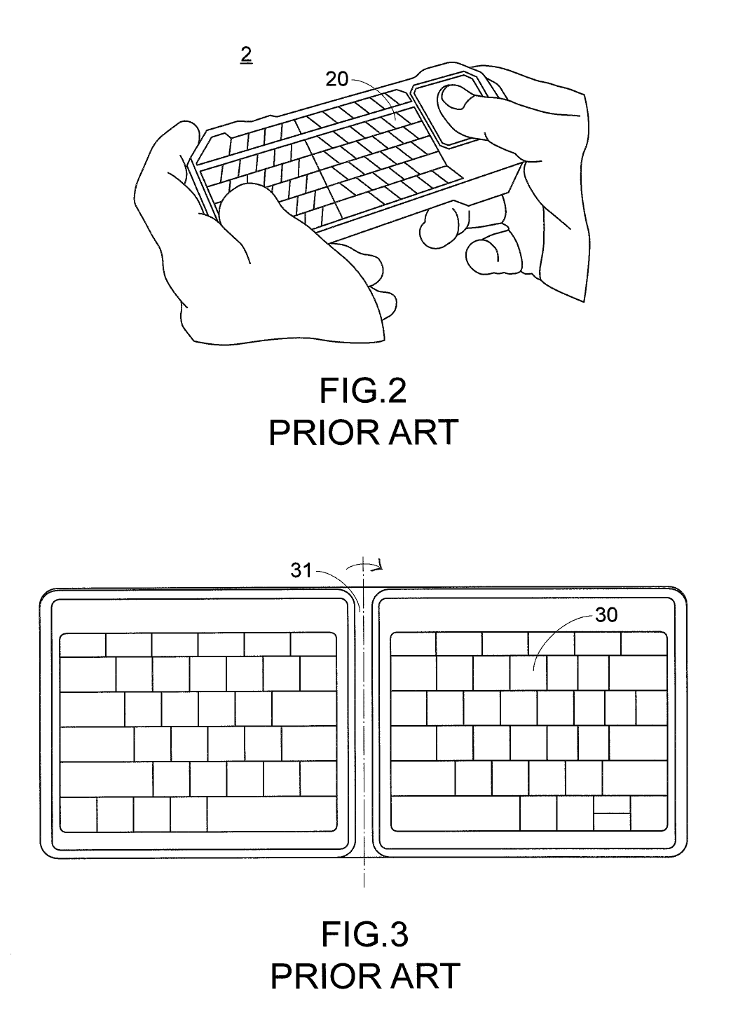

### DETAILED DESCRIPTION OF THE PREFERRED EMBODIMENT

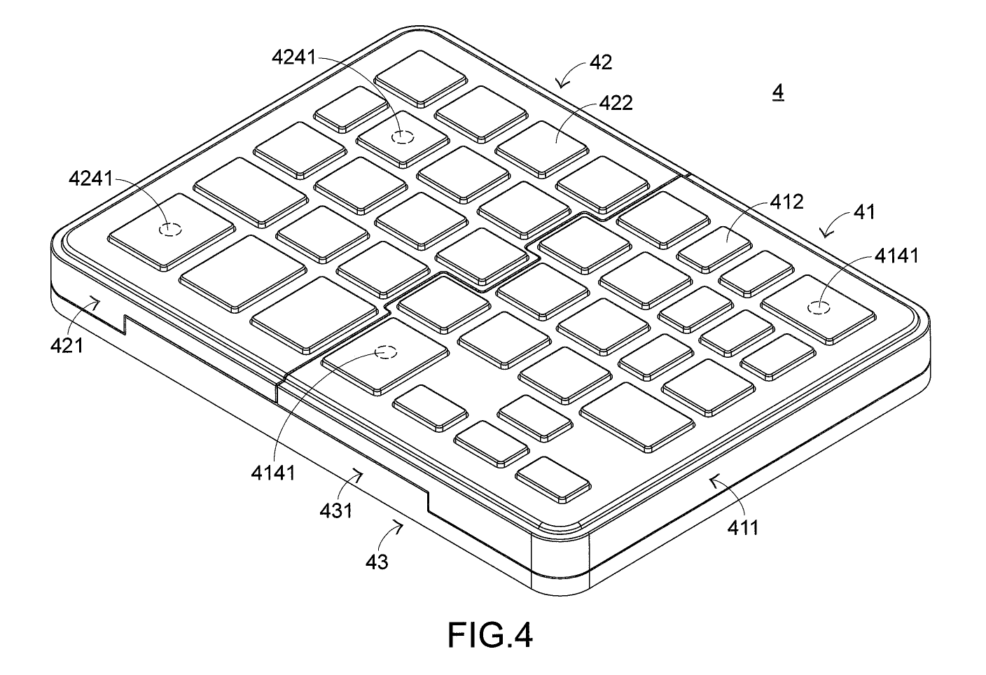

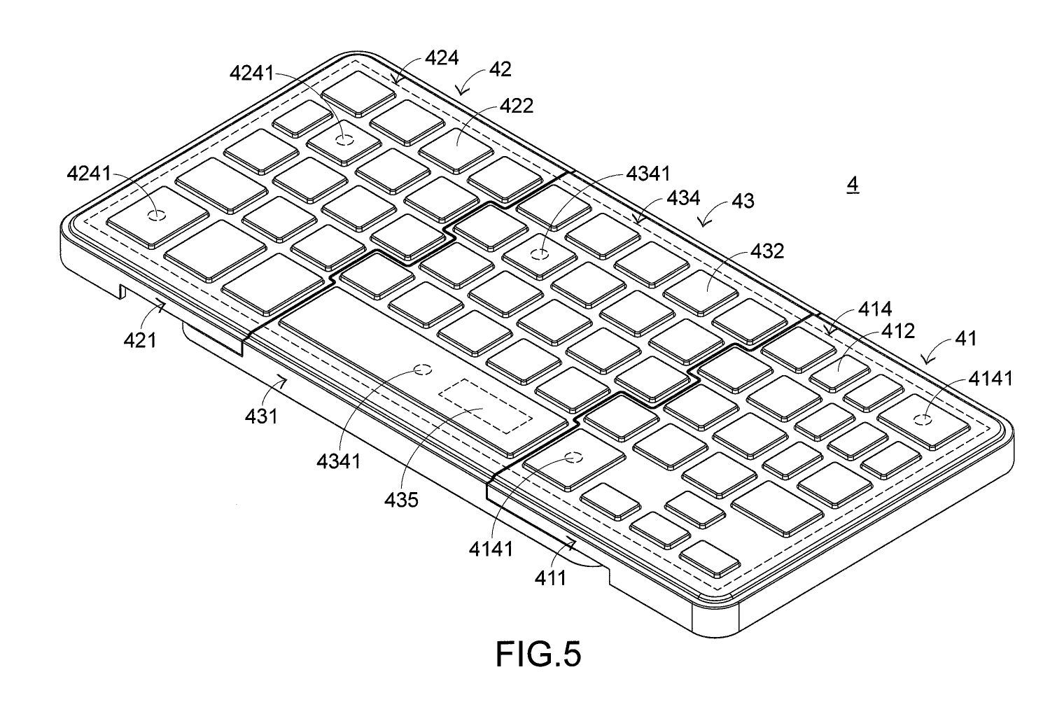

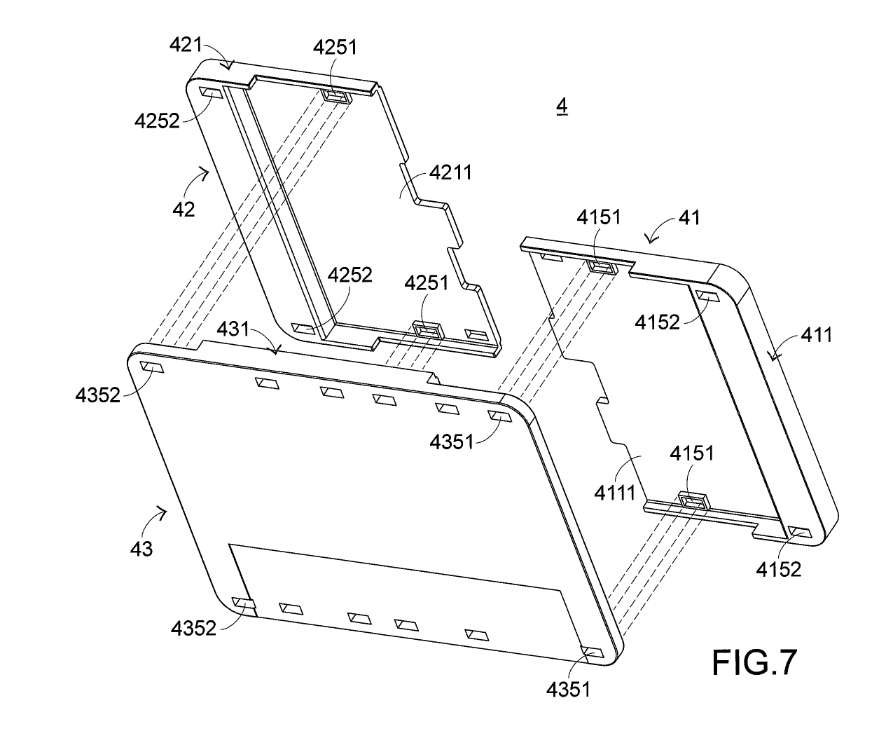

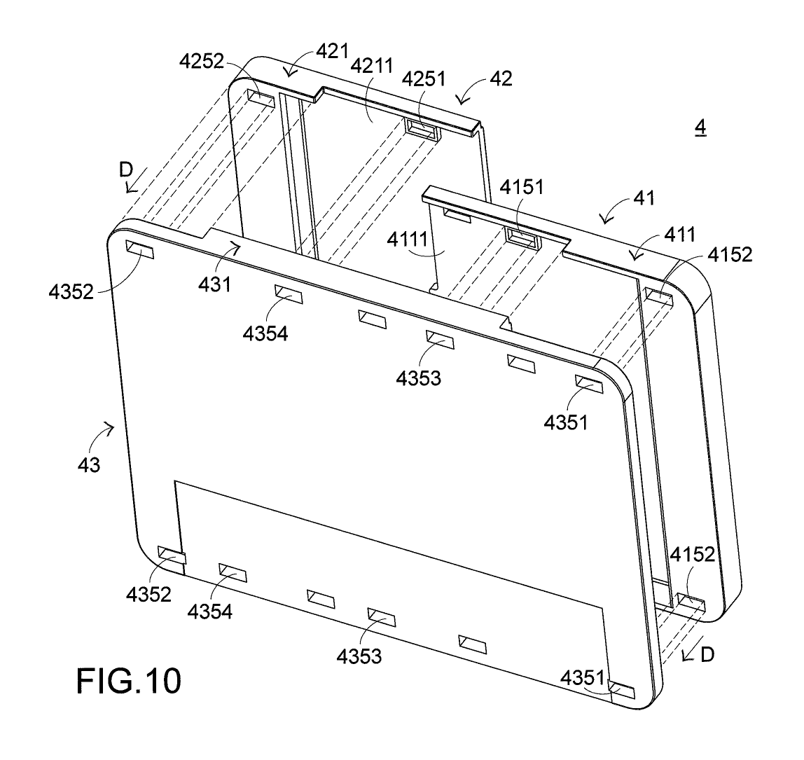

FIG. 4 is a schematic perspective view illustrating a keyboard device according to an embodiment of the present invention, in which the keyboard device is in a stored state. FIG. 5 is a schematic perspective view illustrating keyboard device according to the embodiment of the present invention, in which the keyboard device is in a usage state. As shown in FIGS. 4 and 5, the keyboard device 4 comprises a first keyboard module 41, a second keyboard module 42 and a third keyboard module 43. The first keyboard module 41 comprises a first base 411 and plural first key structures 412. The first base 411 has a first receiving recess 4111 (see FIGS. 7 and 10). The plural first key structures 412 are located over the first base 411. The second keyboard module 42 comprises a second base 421 and plural second key structures 422. The second base 421 has a second receiving recess 4211 (see FIGS. 7 and 10). The plural second key structures 422 are located over the second base 421. The third keyboard module 43 comprises a third base 431 and plural third key structures 432. The plural third key structures 432 are located over the third base 431. The plural first key structures 412, the plural second key structures 422 and the plural third key structures 432 are classified into ordinary keys, numeric keys and function keys. When the keyboard device 4 is in the usage state and one of these key structures is depressed by the user's finger, the keyboard device 4 issues a corresponding key signal to an electronic calculator such as a desktop computer, a notebook computer, a tablet computer or a mobile. According to the key signal, the electronic calculator executes a function corresponding to the depressed key. For example, when an ordinary key is depressed, a corresponding English letter or symbol is inputted into the computer. When a numeric key is depressed, a corresponding number is inputted into the computer. In addition, the function keys (F1˜F12) can be programmed to provide various quick access functions.

When the keyboard device 4 is in the usage state, the first keyboard module 41 and the second keyboard module 42 are horizontally combined with a first side and a second side of the third keyboard module 43, respectively. The first key structures 412 over the first base 411 are supported by a first side of the third base 431 and the first base 411 collaboratively. The second key structures 422 over the second base 421 are supported by a second side of the third base 431 and the second base 421 collaboratively. Consequently, when any first key structure 412 of the first keyboard module 41 is depressed by the user's finger, the first keyboard module 41 is not toppled. Similarly, when any second key structure 422 of the second keyboard module 42 is depressed by the user's finger, the second keyboard module 42 is not toppled.

When the first keyboard module 41 and the third keyboard module 43 are horizontally combined together, the junction between the first keyboard module 41 and the third keyboard module 43 is substantially a flat and contiguous plane. Similarly, when the second keyboard module 42 and the third keyboard module 43 are horizontally combined together, the junction between the second keyboard module 42 and the third keyboard module 43 is substantially a flat and contiguous plane.

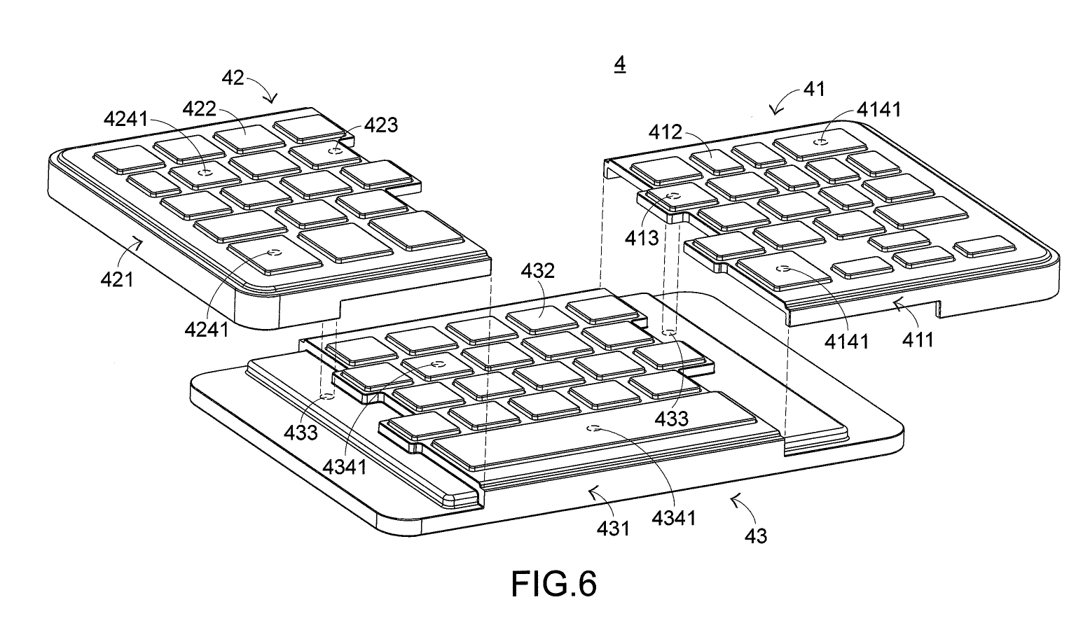

FIG. 6 is a schematic exploded view illustrating keyboard device of FIG. 5 and taken along a viewpoint. FIG. 7 is a schematic exploded view illustrating keyboard device of FIG. 5 and taken along another viewpoint. As shown in FIGS. 6 and 7, the first keyboard module 41 and the second keyboard module 42 are detached from the third keyboard module 43. Moreover, the first keyboard module 41, the second keyboard module 42 and the third keyboard module 43 further comprise a first signal transmission part 413, a second signal transmission part 423 and a third signal transmission part 433, respectively. For succinctness, the first signal transmission part 413, the second signal transmission part 423 and the third signal transmission part 433 are shown in FIG. 6 only. When the first keyboard module 41 and the third keyboard module 43 are horizontally combined together, the first signal transmission part 413 and the third signal transmission part 433 are electrically connected with each other. When the second keyboard module 42 and the third keyboard module 43 are horizontally combined together, the second signal transmission part 423 and the third signal transmission part 433 are electrically connected with each other. Consequently, the third keyboard module 43 and the first keyboard module 41 are in communication with each other, and the third keyboard module 43 and the second keyboard module 42 are in communication with each other.

The ways of establishing the communications between the first keyboard module 41, the second keyboard module 42 and the third keyboard module 43 of the keyboard device 4 are presented herein for purpose of illustration and description only. It is noted that numerous modifications and alterations may be made while retaining the teachings of the invention.

In this embodiment, the first keyboard module 41, the second keyboard module 42 and the third keyboard module 43 further comprise a first membrane circuit board 414, a second membrane circuit board 424 and a third membrane circuit board 434, respectively. For succinctness, the first membrane circuit board 414, the second membrane circuit board 424 and the third membrane circuit board 434 are shown in FIG. 5 only. The first membrane circuit board 414 is disposed on the first base 411. Moreover, the first membrane circuit board 414 comprises plural first key switches 4141 corresponding to the plural first key structures 412. For succinctness, only some first key switches 4141 are shown in the drawings. The second membrane circuit board 424 is disposed on the second base 421. The second membrane circuit board 424 comprises plural second key switches 4241 corresponding to the plural second key structures 422. For succinctness, only some second key switches 4241 are shown in the drawings. The third membrane circuit board 434 is disposed on the third base 431. The third membrane circuit board 434 comprises plural third key switches 4341 corresponding to the plural third key structures 432. For succinctness, only some third key switches 4341 are shown in the drawings.

Moreover, the first signal transmission part 413 of the first keyboard module 41 is disposed on the first base 411 and electrically connected with the first key switches 4141. Similarly, the second signal transmission part 423 of the second keyboard module 42 is disposed on the second base 421 and electrically connected with the second key switches 4241. Moreover, the third keyboard module 43 further comprises a signal processor 435 (see FIG. 5). The plural third key switches 4341 are connected with the signal processor 435 or the third signal transmission part 433. The third signal transmission part 433 is disposed on the third base 431 and electrically connected with the signal processor 435. When the first keyboard module 41 and the third keyboard module 43 are horizontally combined together, the first signal transmission part 413 of the first base 411 is located over the third signal transmission part 433. Moreover, the first signal transmission part 413 is placed downwardly to be contacted or connected with the third signal transmission part 433 of the third base 431. When the second keyboard module 42 and the third keyboard module 43 are horizontally combined together, the second signal transmission part 423 of the second base 421 is located over the third signal transmission part 433. Moreover, the second signal transmission part 423 is placed downwardly to be contacted or connected with the third signal transmission part 433 of the third base 431.

Preferably but not exclusively, at least one of the first signal transmission part 413, the second signal transmission part 423 and the third signal transmission part 433 is a terminal, a pin, a metal dome, a signal transmission pad or any other signal transmission means. The signal transmission means and the ways of contacting or connecting these signal transmission parts are well known to those skilled in the art, and are not redundantly described herein.

When the keyboard device 4 is in the usage state and any first key switch 4141 is triggered to generate a signal, the signal is transmitted to the signal processor 435 through the first signal transmission part 413 and the third signal transmission part 433 sequentially. Consequently, the signal processor 435 generates a correspondingly key signal. Similarly, when any second key switch 4241 is triggered to generate a signal, the signal is transmitted to the signal processor 435 through the second signal transmission part 423 and the third signal transmission part 433 sequentially. Consequently, the signal processor 435 generates a correspondingly key signal. Similarly, when any third key switch 4341 is triggered to generate a signal, the signal is directly transmitted to the signal processor 435 or indirectly transmitted to the signal processor 435 through the third signal transmission part 433. Consequently, the signal processor 435 generates a correspondingly key signal.

The structures and the signal transmission processes of the first membrane circuit board 414 of the first keyboard module 41, the second membrane circuit board 424 of the second keyboard module 42 and the third membrane circuit board 434 of the third keyboard module 43 are well known to those skilled in the art, and are not redundantly described herein.

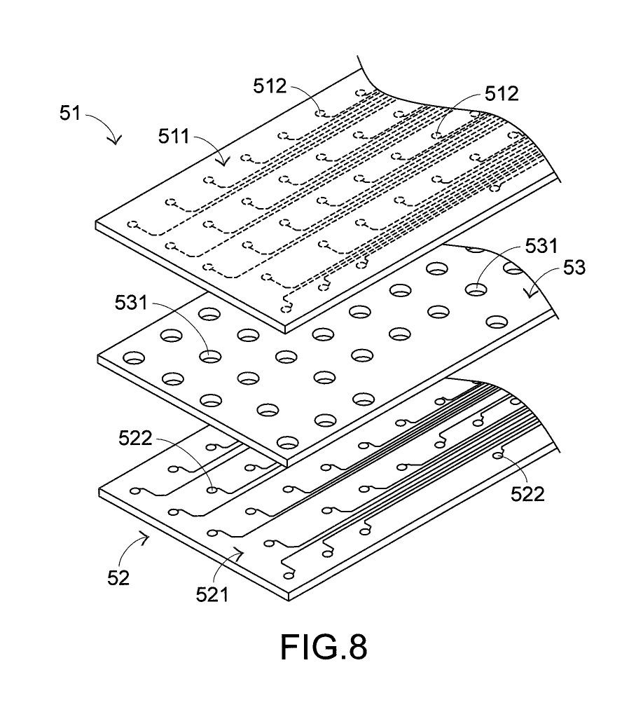

FIG. 8 is a schematic exploded view illustrating the first membrane circuit board, the second membrane circuit board and the third membrane circuit board of the keyboard device as shown in FIG. 5. In this embodiment, each of the first membrane circuit board 414, the second membrane circuit board 424 and the third membrane circuit board 434 comprises an upper film layer 51 and a lower film layer 52. A first circuit pattern 511 is formed on a bottom surface of the upper film layer 51. The first circuit pattern 511 comprises plural upper contacts 512 corresponding to the plural first key structures 412, the plural second key structures 422 or the plural third key structures 423. A second circuit pattern 521 is formed on a top surface of the lower film layer 52. The second circuit pattern 521 comprises plural lower contacts 522 corresponding to the plural upper contacts 512. Each of the upper contacts 512 and the corresponding lower contact 522 are separated from each other by a spacing interval. Moreover, each of the upper contacts 512 and the corresponding lower contact 522 are collectively defined as the first key switch 4141, the second key switch 4241 or the third key switch 4341.

Moreover, for maintaining the spacing interval between each upper contact 512 and the corresponding lower contact 522, an intermediate film layer 53 is arranged between the upper film layer 51 and the lower film layer 52. In addition, the intermediate film layer 53 comprises plural perforations 531 corresponding to the plural upper contacts 512 and the plural lower contacts 522. When one of the first key structures 412, the second key structures 422 and the third key structures 423 is depressed, the corresponding upper contact 512 is contacted with the corresponding lower contact 522 through the corresponding perforation 531. Consequently, the corresponding key switch 4141, 4241 or 4341 is triggered to generate the corresponding signal.

Please refer to FIGS. 5, 6 and 7 again. When the first keyboard module 41 and the third keyboard module 43 are horizontally combined together, the first keyboard module 41 and the third keyboard module 43 are magnetically attracted and fixed by each other. Similarly, when the second keyboard module 42 and the third keyboard module 43 are horizontally combined together, the second keyboard module 42 and the third keyboard module 43 are magnetically attracted and fixed by each other.

In this embodiment, the first keyboard module 41 further comprises a first fixing part 4151 and a second fixing part 4152. The first fixing part 4151 and the second fixing part 4152 are disposed on two opposite sides of the first base 411. Similarly, the second keyboard module 42 further comprises a third fixing part 4251 and a fourth fixing part 4252. The third fixing part 4251 and the fourth fixing part 4252 are disposed on two opposite sides of the second base 421. Similarly, the third keyboard module 43 further comprises a fifth fixing part 4351 and a sixth fixing part 4352. The fifth fixing part 4351 and the sixth fixing part 4352 are disposed on two opposite sides of the third base 431. Moreover, one of the first fixing part 4151 and the fifth fixing part 4351 is a magnetic element, and the other of the first fixing part 4151 and the fifth fixing part 4351 is another magnetic element or a paramagnetic substance (e.g., a metal element). Similarly, one of the second fixing part 4152 and the fifth fixing part 4351 is a magnetic element, and the other of the second fixing part 4152 and the fifth fixing part 4351 is another magnetic element or a paramagnetic substance (e.g., a metal element). Similarly, one of the third fixing part 4251 and the sixth fixing part 4352 is a magnetic element, and the other of the third fixing part 4251 and the sixth fixing part 4352 is another magnetic element or a paramagnetic substance (e.g., a metal element). Similarly, one of the fourth fixing part 4252 and the sixth fixing part 4352 is a magnetic element, and the other of the fourth fixing part 4252 and the sixth fixing part 4352 is another magnetic element or a paramagnetic substance (e.g., a metal element).

When the first keyboard module 41 and the third keyboard module 43 are horizontally combined together, the first fixing part 4151 is located over the fifth fixing part 4351. Since the first fixing part 4151 and the fifth fixing part 4351 are magnetically attracted and fixed by each other, the first keyboard module 41 and the third keyboard module 43 are fixed on each other. When the second keyboard module 42 and the third keyboard module 43 are horizontally combined together, the third fixing part 4251 is located over the sixth fixing part 4352. Since the third fixing part 4251 and the sixth fixing part 4352 are magnetically attracted and fixed by each other, the second keyboard module 42 and the third keyboard module 43 are fixed on each other. In this embodiment, the first keyboard module 41, the second keyboard module 42 and the third keyboard module 43 are combined together through the magnetic attraction. It is noted that ways of fixing these components are not restricted to the magnetic attraction.

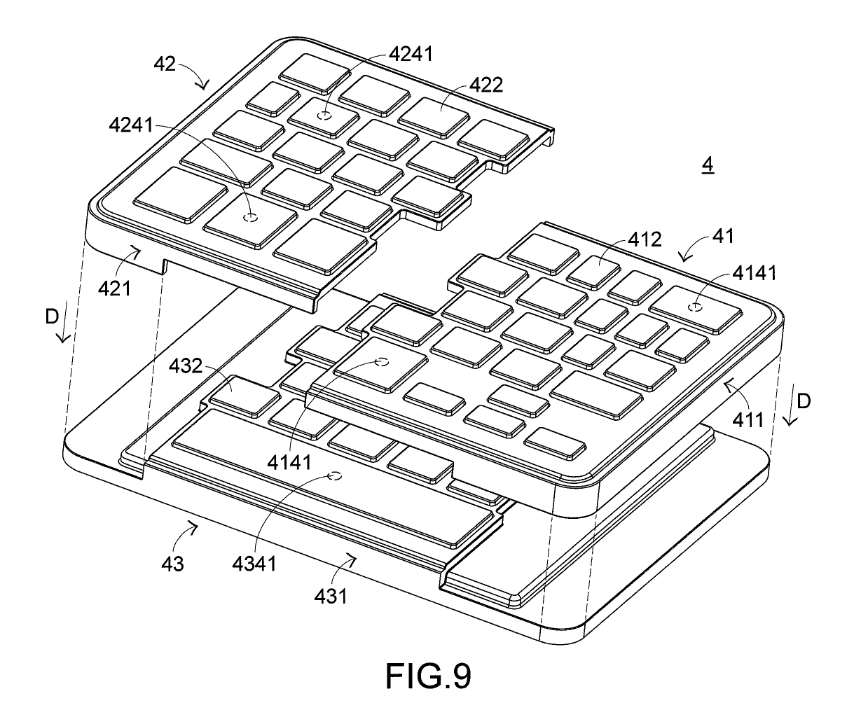

FIG. 9 is a schematic exploded view illustrating keyboard device of FIG. 4 and taken along a viewpoint. FIG. 10 is a schematic exploded view illustrating keyboard device of FIG. 4 and taken along another viewpoint. As shown in FIGS. 9 and 10, the first keyboard module 41, the second keyboard module 42 and the third keyboard module 43 are separated from each other. As shown in FIG. 5, the keyboard device 4 is in the usage state. For storing the keyboard device 4, the first keyboard module 41 and the second keyboard module 42 are detached from the third keyboard module 43 at first. Consequently, the first keyboard module 41 and the second keyboard module 42 are in the detached status as shown in FIG. 6. Then, the first keyboard module 41 and the second keyboard module 42 are moved to the locations as shown in FIGS. 9 and 10. Consequently, the first receiving recess 4111 of the first base 411 and the second receiving recess 4211 of the second base 421 are located over the plural third key structures 432. Afterwards, the first keyboard module 41 and the second keyboard module 42 are moved downwardly in a direction D. Consequently, the plural third key structures 432 are accommodated within an accommodation space that is defined by the first receiving recess 4111 and the second receiving recess 4211 collaboratively. The resulting structure of the keyboard device 4 in the stored state is shown in FIG. 4.

When the keyboard device 4 is in the stored state, the first keyboard module 41 and the second keyboard module 42 are horizontally combined together. Moreover, as shown in FIG. 4, the junction between the first keyboard module 41 and the second keyboard module 42 is substantially a flat and contiguous plane. Meanwhile, the second fixing part 4152 is located over the fifth fixing part 4351, and the fourth fixing part 4252 is located over the sixth fixing part 4352. Due to the magnetic attraction between the second fixing part 4152 and the fifth fixing part 4351, the first keyboard module 41 is fixed on the third keyboard module 43. Similarly, due to the magnetic attraction between the fourth fixing part 4252 and the sixth fixing part 4352, the second keyboard module 42 is fixed on the third keyboard module 43. In this embodiment, the first keyboard module 41 and the second keyboard module 42 are combined together through the magnetic attraction. It is noted that ways of fixing these components are not restricted to the magnetic attraction.

Preferably but not exclusively, the third keyboard module 43 further comprises a seventh fixing part 4353 and an eighth fixing part 4354. The seventh fixing part 4353 and the eighth fixing part 4354 are disposed on the third base 431 and arranged between the fifth fixing part 4351 and the sixth fixing part 4352. Moreover, one of the first fixing part 4151 and the seventh fixing part 4353 is a magnetic element, and the other of the first fixing part 4151 and the seventh fixing part 4353 is another magnetic element or a paramagnetic substance (e.g., a metal element). Similarly, one of the third fixing part 4251 and the eighth fixing part 4354 is a magnetic element, and the other of the third fixing part 4251 and the eighth fixing part 4354 is another magnetic element or a paramagnetic substance (e.g., a metal element). When the keyboard device 4 is in the stored state, the first fixing part 4151 is located over the seventh fixing part 4353, and the third fixing part 4251 is located over the eighth fixing part 4354. Due to the magnetic attraction between the first fixing part 4151 and the seventh fixing part 4353, the first keyboard module 41 is fixed on the third keyboard module 43 more securely. Similarly, due to the magnetic attraction between the third fixing part 4251 and the eighth fixing part 4354, the second keyboard module 42 is fixed on the third keyboard module 43 more securely.

The eight fixing parts 4151˜4354 shown in FIG. 7 and FIG. 10 are exposed outside. It is noted that the examples of the fixing parts are not restricted. For example, in some other embodiments, any of the eight fixing parts 4151˜4354 is embedded within the corresponding base. Consequently, the appearance is aesthetically pleasing.

From the above descriptions, the present invention provides the keyboard device. The keyboard device can be disassembled into plural individual keyboard modules. By changing the combination of these keyboard modules, the operating state of the keyboard device is switched from the usage state to the stored state or switched from the stored state to the usage state. Even if the size of the key structure is not reduced and the distance between every two adjacent key structures is shortened, the overall volume of the keyboard device of the present invention in the stored state is largely reduced. Consequently, the keyboard device of the present invention is suitably carried. Since the size of the key structure and the distance between every two adjacent key structures are not changed, the tactile feel and operating convenience of the keyboard device to the user are not adversely affected. In other words, the keyboard device of the present invention is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard device, comprising:
a first keyboard module comprising a first base and plural first key structures, wherein the plural first key structures are located over the first base, and the first base has a first receiving recess;
a second keyboard module comprising a second base and plural second key structures, wherein the plural second key structures are located over the second base, and the second base has a second receiving recess;
a third keyboard module comprising plural third key structures and a third base, wherein the third base is located under the plural third key structures to support the plural third key structures,
wherein when the keyboard device is in a stored state, the first base and the second base are located over the third base, and the plural third key structures are accommodated within an accommodation space that is defined by the first receiving recess and the second receiving recess, wherein when the keyboard device is in a usage state, the first keyboard module and the second keyboard module are detached from each other, the first keyboard module and the second keyboard module are horizontally and respectively combined with a first lateral side and a second lateral side of the third keyboard module, the plural first key structures are supported by a first side of the third base and the first base collaboratively, and the plural second key structures are supported by a second side of the third base and the second base collaboratively.

2. The keyboard device according to claim 1, wherein the first keyboard module, the second keyboard module and the third keyboard module further comprise a first signal transmission part, a second signal transmission part and a third signal transmission part, respectively, wherein when the first keyboard module and the third keyboard module are horizontally combined together, the first signal transmission part and the third signal transmission part are electrically connected with each other, wherein when the second keyboard module and the third keyboard module are horizontally combined together, the second signal transmission part and the third signal transmission part are electrically connected with each other.

3. The keyboard device according to claim 2, wherein at least one of the first signal transmission part, the second signal transmission part and the third signal transmission part is a terminal, a pin, a metal dome or a signal transmission pad.

4. The keyboard device according to claim 2, wherein the first keyboard module further comprises plural first key switches, and the first signal transmission part is disposed on the first base and electrically connected with the plural first key switches; or the second keyboard module further comprises plural second key switches, and the second signal transmission part is disposed on the second base and electrically connected with the plural second key switches; or the third keyboard module further comprises plural third key switches and a signal processor, the plural third key switches are electrically connected with the signal processor or the third signal transmission part, and the third signal transmission part is disposed on the third base and electrically connected with the signal processor.

5. The keyboard device according to claim 1, wherein the first keyboard module further comprises a first fixing part and a second fixing part, the third keyboard module further comprises a fifth fixing part, the first keyboard module is fixed on the third keyboard module through the first fixing part and the fifth fixing part when the keyboard device is in the usage state, and the first keyboard module is fixed on the third keyboard module through the second fixing part and the fifth fixing part when the keyboard device is in the stored state; or the second keyboard module further comprises a third fixing part and a fourth fixing part, the third keyboard module further comprises a sixth fixing part, the second keyboard module is fixed on the third keyboard module through the third fixing part and the sixth fixing part when the keyboard device is in the usage state, and the second keyboard module is fixed on the third keyboard module through the fourth fixing part and the sixth fixing part when the keyboard device is in the stored state.

6. The keyboard device according to claim 5, wherein the first fixing part and the second fixing part are disposed on two opposite sides of the first base, the third fixing part and the fourth fixing part are disposed on two opposite sides of the second base, and the fifth fixing part and the sixth fixing part are respectively disposed on the first side and the second side of the third base.

7. The keyboard device according to claim 5, wherein at least one of the first fixing part, the second fixing part, the third fixing part, the fourth fixing part, the fifth fixing part and the fixing part is a magnetic element.

8. The keyboard device according to claim 1, wherein when the keyboard device is in the usage state, the first keyboard module and the third keyboard module are magnetically attracted and fixed by each other, wherein when the keyboard device is in the usage state, the second keyboard module and the third keyboard module are magnetically attracted and fixed by each other, wherein when the keyboard device is in the stored state, the first keyboard module and the second keyboard module are magnetically attracted and fixed by each other.

9. The keyboard device according to claim 1, wherein the first keyboard module further comprises a first membrane circuit board, and the first membrane circuit board is disposed on the first base and comprises plural first key switches corresponding to the plural first key structures; or the second keyboard module further comprises a second membrane circuit board, and the second membrane circuit board is disposed on the second base and comprises plural second key switches corresponding to the plural second key structures; or the third keyboard module further comprises a third membrane circuit board, and the third membrane circuit board is disposed on the third base and comprises plural third key switches corresponding to the plural third key structures.

10. The keyboard device according to claim 9, wherein at least one of the first membrane circuit board, the second membrane circuit board and the third membrane circuit board comprises an upper film layer and a lower film layer, wherein a first circuit pattern is formed on the upper film layer, a second circuit pattern is formed on the lower film layer, the first circuit pattern comprises an upper contact, and the second circuit pattern comprises a lower contact, wherein the upper contact and the lower contact are separated from each by a spacing interval and collectively defined as one of the first key switch, the second key switch and the third key switch.

11. The keyboard device according to claim 1, wherein when the keyboard device is in the stored state, a junction between the first keyboard module and the second keyboard module is a first flat and contiguous plane, wherein when the first keyboard module and the third keyboard module are horizontally combined together, a junction between the first keyboard module and the third keyboard module is a second flat and contiguous plane, wherein when the second keyboard module and the third keyboard module are horizontally combined together, a junction between the second keyboard module and the third keyboard module is a third flat and contiguous plane.

12. A keyboard device, comprising:
a first keyboard module comprising a first base, a first signal transmission part and plural first key structures, wherein the plural first key structures are located over the first base;
a second keyboard module comprising a second base, a second signal transmission part and plural second key structures, wherein the plural second key structures are located over the second base;
a third keyboard module comprising a third base, a third signal transmission part and plural third key structures, wherein the plural third key structures are located over the third base,
when the keyboard device is in a stored state, the first keyboard module and the second keyboard module are combined together and the first base and the second base are located over or under the third base, wherein when the keyboard device is in a usage state, the first keyboard module and the second keyboard module are detached from each other, the first keyboard module and the second keyboard module are horizontally combined with a first lateral side and a second lateral side of the third keyboard module, respectively, and the first signal transmission part and the second signal transmission part are electrically connected with the third signal transmission part.

13. The keyboard device according to claim 12, wherein when the first keyboard module and the third keyboard module are combined together, the first signal transmission part is located over the third signal transmission part, wherein when the second keyboard module and the third keyboard module are combined together, the second signal transmission part is located over the third signal transmission part.

14. The keyboard device according to claim 12, wherein at least one of the first signal transmission part, the second signal transmission part and the third signal transmission part is a terminal, a pin, a metal dome or a signal transmission pad.

15. The keyboard device according to claim 12, wherein the first keyboard module further comprises plural first key switches and the first signal transmission part is disposed on the first base and electrically connected with the plural first key switches; or the second keyboard module further comprises plural second key switches and the second signal transmission part is disposed on the second base and electrically connected with the plural second key switches; or the third keyboard module further comprises plural third key switches and a signal processor, the plural third key switches are electrically connected with the signal processor or the third signal transmission part, and the third signal transmission part is disposed on the third base and electrically connected with the signal processor.

16. The keyboard device according to claim 12, wherein the first keyboard module further comprises a first fixing part and a second fixing part, the third keyboard module further comprises a fifth fixing part, the first keyboard module is fixed on the third keyboard module through the first fixing part and the fifth fixing part when the keyboard device is in the usage state, and the first keyboard module is fixed on the third keyboard module through the second fixing part and the fifth fixing part when the keyboard device is in the stored state; or the second keyboard module further comprises a third fixing part and a fourth fixing part, the third keyboard module further comprises a sixth fixing part, the second keyboard module is fixed on the third keyboard module through the third fixing part and the sixth fixing part when the keyboard device is in the usage state, and the second keyboard module is fixed on the third keyboard module through the fourth fixing part and the sixth fixing part when the keyboard device is in the stored state.

17. The keyboard device according to claim 16, wherein the first fixing part and the second fixing part are disposed on two opposite sides of the first base, the third fixing part and the fourth fixing part are disposed on two opposite sides of the second base, and the fifth fixing part and the sixth fixing part are disposed on two opposite sides of the third base.

18. The keyboard device according to claim 16, wherein at least one of the first fixing part, the second fixing part, the third fixing part, the fourth fixing part, the fifth fixing part and the fixing part is a magnetic element.

19. The keyboard device according to claim 12, wherein when the keyboard device is in the usage state, the first keyboard module and the third keyboard module are magnetically attracted and fixed by each other, wherein when the keyboard device is in the usage state, the second keyboard module and the third keyboard module are magnetically attracted and fixed by each other, wherein when the keyboard device is in the stored state, the first keyboard module and the second keyboard module are magnetically attracted and fixed by each other.

20. The keyboard device according to claim 12, wherein the first keyboard module further comprises a first membrane circuit board, and the first membrane circuit board is disposed on the first base and comprises plural first key switches corresponding to the plural first key structures; or the second keyboard module further comprises a second membrane circuit board, and the second membrane circuit board is disposed on the second base and comprises plural second key switches corresponding to the plural second key structures; or the third keyboard module further comprises a third membrane circuit board, and the third membrane circuit board is disposed on the third base and comprises plural third key switches corresponding to the plural third key structures.
